(19) United States
(12) Patent Application Publication
(10) Pub. No.: US 2020/0101932 A1
(43) Pub. Date: Apr. 2, 2020

(54) SIDE AIRBAG APPARATUS AND WRAPPING MATERIAL

(71) Applicant: TOYODA GOSEI CO., LTD., Kiyosu-shi (JP)

(72) Inventors: Shohei OTA, Kiyosu-shi (JP); Koji SHIBAYAMA, Kiyosu-shi (JP)

(21) Appl. No.: 16/577,224

(22) Filed: Sep. 20, 2019

(30) Foreign Application Priority Data
Sep. 28, 2018 (JP) 2018-183249

(51) Int. Cl. B60R 21/231; B60R 21/207

(52) U.S. Cl. CPC B60R 21/23138; B60R 2021/23146; B60R 21/207

(57) ABSTRACT

A side airbag apparatus includes: an airbag module including: a side airbag configured to be deployed and inflated when a gas is filled inside the side airbag, and a retainer configured to attach the side airbag in a folded state to an attachment target of a conveyance; and a wrapping material that houses the airbag module and configured to be broken when the side airbag is deployed and inflated. The wrapping material includes a winding band wound around the wrapping material in a state in which the airbag module is housed.

### CROSS-REFERENCE TO RELATED APPLICATIONS

This application is based upon and claims the benefit of priority from prior Japanese patent application No. 2018-183249, filed on Sep. 28, 2018, the entire contents of which are incorporated herein by reference.

### TECHNICAL FIELD

The present invention relates to a side airbag apparatus that, when impact is applied to a conveyance, deploys and inflates a side airbag to protect an occupant from the impact, and a wrapping material used in the apparatus.

### BACKGROUND ART

In related art, for example, a side airbag apparatus of an automobile includes an airbag module including a folded side airbag and a gas generator for supplying inflation gas to the side airbag. JP-A-2017-30511 discloses a side airbag apparatus including a wrapping material disposed in a manner folded around an airbag module. In this side airbag apparatus, folding collapse of the side airbag is prevented by the wrapping material.

Incidentally, the side airbag apparatus is carried in a state in which the airbag module is housed in the wrapping material. At this time, if there is a gap between the airbag module and the wrapping material, foreign matters may enter an inside of the wrapping material.

An object of the present invention is to provide a side airbag apparatus and a wrapping material that are capable of preventing intrusion of foreign matters.

### SUMMARY OF INVENTION

According to an aspect of the invention, there is provided a side airbag apparatus including: an airbag module including: a side airbag configured to be deployed and inflated when a gas is filled inside the side airbag, and a retainer configured to attach the side airbag in a folded state to an attachment target of a conveyance; and a wrapping material that houses the airbag module and configured to be broken when the side airbag is deployed and inflated, the wrapping material including a winding band wound around the wrapping material in a state in which the airbag module is housed.

### BRIEF DESCRIPTION OF DRAWINGS

FIG. 1 is a side view showing a side airbag apparatus incorporated in a conveyance seat from a vehicle outer side together with an occupant.

FIG. 2 is a cross-sectional view showing a state in which the side airbag apparatus is incorporated in a seat back.

FIG. 3 is a side view showing the side airbag apparatus in a state in which an airbag module is housed in a wrapping material.

FIG. 4 is a side view showing the wrapping material before the airbag module is housed.

FIG. 5 is a side view showing the airbag module in a state in which the airbag is folded.

### DESCRIPTION OF EMBODIMENTS

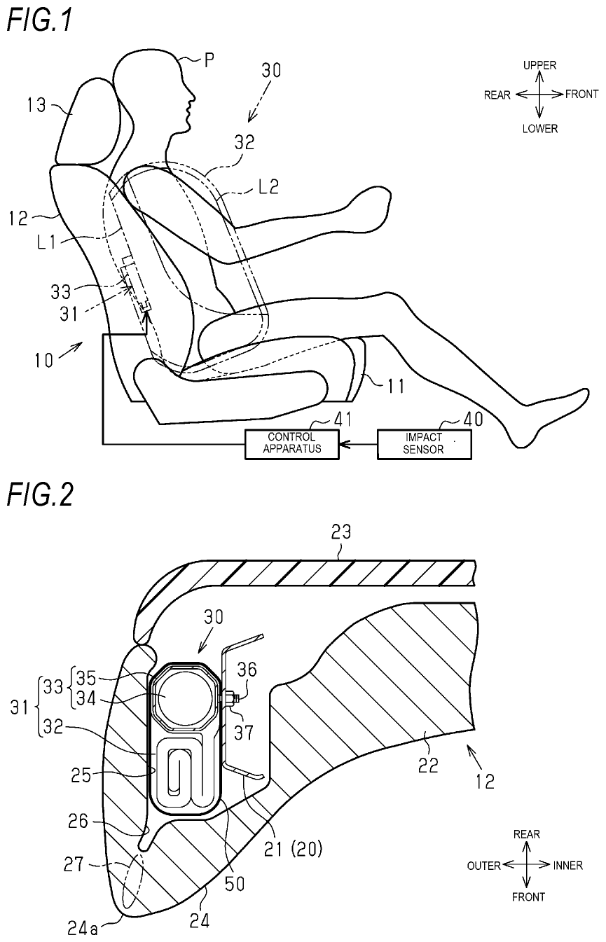

Hereinafter, an embodiment of a side airbag apparatus for vehicle and a wrapping material used in the apparatus will be described with reference to FIGS. 1 to 5.

Hereinafter, a forward direction and a rearward direction of a vehicle will be described as front and rear, respectively. With respect to a central portion in a vehicle width direction, a side closer to the central portion in the vehicle width direction is defined as a vehicle inner side, and a side away from the central portion will be described as a vehicle outer side.

As shown in FIG. 1, a vehicle seat 10 as an attachment target to a conveyance is provided in a vehicle. A front-rear direction and a width direction of the vehicle seat 10 coincide with a vehicle front-rear direction and the vehicle width direction, respectively. The vehicle seat 10 includes a seat cushion 11, a seat back 12 that is erected from a rear end portion of the seat cushion 11 and allows adjustment of an angle of inclination, and a headrest 13 attached to an upper end portion of the seat back 12.

As shown in FIG. 2, a seat frame 20 is disposed inside the seat back 12. The seat frame 20 is made of a metal plate, and has a pair of side frame portions 21 extending in an upper-lower direction. In the same drawing, a side frame portion 21 on the vehicle outer side is shown.

A seat pad 22 made of an elastic material such as urethane foam is disposed on a front side of the seat frame 20 including the side frame portions 21. A hard back board 23 made of a synthetic resin or the like is disposed on a rear side of the seat frame 20.

A pair of side support portions 24 projecting toward a front side of the other portions of the seat pad 22 are provided on both side portions of the seat pad 22 in the vehicle width direction. In the same drawing, the side support portion 24 on the vehicle outer side is shown.

A housing portion 25 is provided between the seat pad 22 and the backboard 23. A side airbag apparatus 30 is incorporated in the housing portion 25. In the present embodiment, the housing portion 25 is located on a rear side of the side support portion 24 on the vehicle outer side of the seat pad 22, and on the vehicle outer side of the side frame portion 21. A slit 26, which extends obliquely so as to be located on the vehicle outer side toward the front side, is formed at a corner portion on the vehicle outer side of the housing portion 25. A portion between a corner portion 24a on the vehicle outer side of a front portion of the side support portion 24 and the slit 26 constitutes a breakage-planned portion 27 that is broken when the side airbag apparatus 30 is deployed and inflated.

As shown in FIGS. 1 and 2, the side airbag apparatus 30 includes an airbag module 31. The airbag module 31 includes an airbag 32, which is a side airbag, and a gas generator 33. A shape of the airbag module 31 is an elongated shape extending substantially in the upper-lower direction of the vehicle along inclination of the seat back 12 in a state in which the airbag module 31 is stored in the housing portion 25. The airbag 32 is formed by folding one fabric piece into two at a folding line L1 set at a central portion thereof, overlapping the fabric piece with itself in the vehicle width direction, and coupling overlapping portions thereof at a coupling line L2 so as to form a bag shape. The airbag 32 is housed in a state folded in the housing portion 25, and is deployed and inflated when a gas is filled inside the airbag 32. The folded airbag 32 has an elongated shape, and constitutes most of an outer shape of the airbag module 31.

The gas generator 33 includes an inflator 34 that supplies inflation gas of the airbag 32, and a retainer 35 that holds the inflator 34. The gas generator 33 has an elongated shape along a longitudinal direction of the folded airbag 32. The gas generator 33 is disposed on the rear side of the vehicle with respect to the airbag 32 in the state in which the gas generator 33 is stored in the housing portion 25. In the present embodiment, the inflator 34 may be a pyro-type inflator that generates an inflation gas by combustion of an explosive. That is, the inflator 34 houses a gas generating agent that generates an inflation gas inside a substantially cylindrical housing. An upper end portion of the inflator 34 is inserted into the airbag 32, and a gas is ejected therefrom. A harness (not shown) serving as an input wiring for an operation signal to the inflator 34 is connected to a lower end portion of the inflator 34.

The inflator 34, instead of the pyrotechnic type, can be modified to a hybrid type that ejects an inflation gas by breaking a partition wall of a high-pressure gas cylinder filled with a high-pressure gas by an explosive or the like.

The retainer 35 attaches the inflator 34 to the side frame portion 21 together with the airbag 32. The retainer 35 is made of a metal plate and has a substantially cylindrical shape. The inflator 34 is inserted into the retainer 35.

As shown in FIG. 2, two attachment bolts 36, which serve as attachment projections for attaching the retainer 35 to the side frame portion 21, are provided on a side surface of the retainer 35 on the vehicle inner side. The attachment bolts 36 protrude toward the vehicle inner side at an interval in a longitudinal direction of the retainer 35. In a state in which the attachment bolts 36 are respectively inserted into bolt holes (not shown) of the side frame portion 21, nuts 37 are respectively fastened to the attachment bolts 36 from the vehicle inner side, so that the airbag module 31 is attached to the side frame portion 21.

The present embodiment is exemplified as including the gas generator 33 in which the inflator 34 and the retainer 35 are separate, but may also include a gas generator 33 in which the inflator 34 and the retainer 35 are integrated with each other.

As shown in FIG. 1, the side airbag apparatus 30 includes an impact sensor 40 configured with an acceleration sensor or the like, and a control apparatus 41. The impact sensor 40 is provided on a side wall portion of the vehicle, and detects impact applied from a lateral side to the side wall portion. The control apparatus 41 is connected to the inflator 34 via the harness, and controls operation of the inflator 34 based on a detection signal from the impact sensor 40. The side airbag apparatus 30 supplies the inflation gas to the airbag 32 by operation of the inflator 34, and expands and inflates the airbag 32 between the side wall portion of the vehicle and the vehicle seat 10, so as to protect the occupant P seated on the vehicle seat 10 from the impact. The airbag 32 is deployed and inflated toward a front side of the vehicle along the slit 26 and the breakage-planned portion 27 of the seat back 12 in accordance with breakage of the seat back 12.

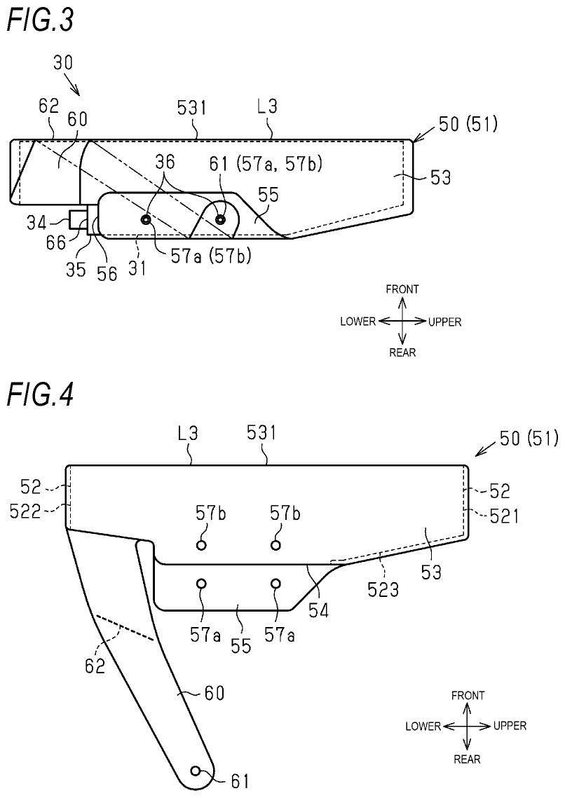

As shown in FIGS. 3 and 4, the side airbag apparatus 30 includes a wrapping material 50 that houses the airbag module 31. The wrapping material 50 is made of a sheet material 51, which is a fabric piece. The sheet material 51 is preferably a nonwoven fabric made of synthetic resin fibers, for example. The wrapping material 50 wraps the airbag 32 in a folded state, and prevents a folded shape from collapse (unfolding) when the airbag module 31 is transported or before the airbag module 31 is assembled to the housing portion 25. The wrapping material 50 is broken when the airbag 32 is deployed and inflated.

In FIGS. 3 and 4, when the side airbag apparatus 30 is attached to the side frame portion 21, an upper side of the paper is the front of the vehicle, a left side of the paper is a vehicle lower side, and a vertically upward direction with respect to the paper is the vehicle inner side. Here, inclination of the side airbag apparatus 30 in the vehicle upper-lower direction (the inclination of the seat back 12) is that a longitudinal direction of the side airbag apparatus 30 is along the vehicle upper-lower direction.

As shown in FIG. 4, the wrapping material 50 includes a main body portion 53 having an elongated bag shape obtained by folding the sheet material 51 at a folding line L3 and joining a part of peripheral portions 52 that overlap each other. In this embodiment, the folding line L3 is located on the front side of the main body portion 53 in a state in which the main body portion 53 is attached to the side frame portion 21. An upper edge portion 521, a lower edge portion 522, and an upper portion 523 of a rear edge portion of the peripheral portions 52 are joined by welding. A shape of the main body portion 53 is along an outer shape of the airbag module 31.

The main body portion 53 has an opening 54 obtained by opening a part of the bag shape. The opening 54 is formed by an unjoined portion of a periphery of the main body portion 53 (see FIG. 4). The opening 54 of the present embodiment faces toward the rear side in a state in which the main body portion 53 is attached to the side frame portion 21. The airbag module 31 is housed in a manner inserted into the main body portion 53 through the opening 54.

A flap portion 55 is provided at a central portion of a rear-side edge portion of the peripheral portions 52, which is a part of the peripheral portions 52 located on the vehicle outer side.

As shown in FIG. 3, in a state in which the airbag module 31 is housed, the flap portion 55 overlaps a surface of the main body portion 53 on the vehicle inner side so as to block the opening 54. A window portion 56, which is a hole communicating an inside and an outside of the wrapping material 50, is provided in a lower portion of the flap portion 55 in a state in which the flap portion 55 overlaps the surface of the main body portion 53 on the vehicle inner side. Therefore, the flap portion 55 exposes the airbag module 31 from the window portion 56 while covering the airbag module 31 with a part blocking the opening 54.

As shown in FIGS. 3 and 4, a plurality of (two in the present embodiment) through holes 57a and a plurality of (two in the present embodiment) through holes 57b, through which attachment bolts 36 penetrate when the airbag module 31 is housed, are formed at intervals in the longitudinal direction on the flap portion 55 and a part of the main body portion 53 overlapped with the flap portion 55. The flap portion 55 is held in a state in which the flap portion 55 overlaps the surface of the main body portion 53 on the vehicle inner side, in a state in which the attachment bolts 36 penetrate the through holes 57a.

A winding band 60 extends from a lower end portion of a rear side edge portion of a part of the peripheral portions 52 located on the vehicle outer side. The winding band 60 is provided integrally with the main body portion 53, and extends obliquely with respect to a longitudinal direction of the main body portion 53 so as to be located on an upper side in the extending direction. The winding band 60 is wound around the main body portion 53 while blocking the opening 54, in a state in which the airbag module 31 is housed in the main body portion 53 and the flap portion 55 is overlapped with the main body portion 53. Since the opening 54 of the main body portion 53 is blocked by the winding band 60 and the flap portion 55, the airbag module 31 is covered by the wrapping material 50 except for a part exposed from the window portion 56.

The winding band 60 has a through hole 61 through which the attachment bolt 36 located on the upper side penetrates in a state in which the winding band 60 is wound around the wrapping material 50. Since the attachment bolt 36 penetrates the through hole 61, the winding band 60 is held in a state in which the winding band 60 is wound around the wrapping material 50 while being in close contact with both the surface on the inner side and the surface on the outer side of the main body portion 53.

A breaking portion 62, which is more fragile than other portions of the winding band, is provided at an intermediate portion in an extending direction of the winding band 60. The breaking portion 62 is configured with perforations extending in a direction intersecting the extending direction of the winding band 60. In a state in which the winding band 60 is wound around the main body portion 53, the breaking portion 62 overlaps the front edge portion 531 (the folding line L3) of the main body portion 53. That is, the breaking portion 62 is provided at a position corresponding to a deployment direction of the airbag 32. Perforations extending along the folding line L3 are formed on the front edge portion 531 of the main body portion 53.

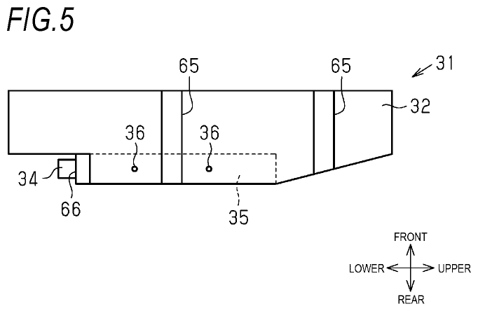

As shown in FIG. 5, tapes 65 for holding the airbag 32 in the folded state are wound on the airbag 32.

As shown in FIGS. 2 and 3, the retainer 35 is located on the rear side of the airbag module 31.

As shown in FIGS. 3 and 5, the inflator 34 is inserted through an insertion opening 66 of the retainer 35. By caulking a peripheral portion of the insertion opening 66, the inflator 34 is locked inside the retainer 35.

As shown in FIG. 3, the insertion opening 66 is exposed to the outside of the wrapping material 50 from the window portion 56 in a state in which the retainer 35 is housed in the wrapping material 50.

Next, effects of the side airbag apparatus and the wrapping material used in the apparatus of the present embodiment will be described.

(1) The side airbag apparatus 30 includes the wrapping material 50 that houses the airbag module 31, and the wrapping material 50 includes the winding band 60 wound around the main body portion 53 in the state in which the airbag module 31 is housed. According to the above configuration, since the winding band 60 is wound around the wrapping material 50, the gap between the airbag module 31 and the wrapping material 50 can be reduced, and entry of foreign matters into the wrapping material 50 can be prevented.

(2) The winding band 60 is provided integrally with the main body portion 53 of the wrapping material 50. According to this configuration, the number of components can be reduced as compared with the case where the wrapping material 50 and the winding band 60 are provided separately.

(3) The retainer 35 has the attachment bolts 36 configured to be attached to the vehicle seat 10, and the winding band 60 has the through hole 61 penetrated by one of the attachment bolts 36 in the state in which the winding band 60 is wound around the main body portion 53. According to this configuration, the winding band 60 can be held in a state in which the winding band 60 is wound around the main body portion 53 by using the attachment bolt 36 configured to be attached to the vehicle seat 10. Accordingly, a member for holding the winding band 60 in the wrapped state is not separately provided, which contributes to prevention of increase in the number of components.

(4) The winding band 60 has the breaking portion 62, which is more fragile than the other portions of the winding band 60, at the position corresponding to the direction in which the airbag 32 is deployed and inflated. According to this configuration, the breaking portion 62 is rapidly broken when the airbag 32 is deployed and inflated. Accordingly, since the airbag 32 can be inflated and inflated rapidly, the function of protecting the occupant is ensured.

(5) The retainer 35 has the insertion opening 66 into which the inflator 34 is inserted, and the insertion opening 66 is exposed to the outside of the wrapping material 50. According to this configuration, in the case where the inflator 34 is to be inserted into the retainer 35 housed in the wrapping material 50, since the insertion opening 66 of the retainer 35 is exposed, the inflator 34 can be easily inserted. This contributes to improvement of the assembling property of the side airbag apparatus 30.

(6) The wrapping material 50 has the opening 54 on the main body portion 53 formed into the elongated bag shape. In addition, the winding band 60 blocks the opening 54 in the state in which the winding band 60 is wound around the main body portion 53. According to this configuration, the airbag module is inserted into the wrapping material 50 through the opening 54 provided on the wrapping material 50. Further, since the winding band 60 is wound around the main body portion 53 so as to block the opening, intrusion of foreign matters from the opening 54 is prevented. Therefore, it contributes to prevention of intrusion of foreign matters while ensuring the assembling property.

The present embodiment may be modified and implemented as follows. The present embodiment and the following modifications can be implemented in combination with each other as long as they do not have technical contradiction.
Joining of the peripheral portions 52 of the wrapping material 50 is not limited to welding, and may be adhesion or stitching.
The breaking portion 62 provided on the winding band 60 is not limited to a portion configured with perforations, and may be a portion more fragile than the other portions of the winding band 60, such as being partially thinned.
The breaking portion 62 may be omitted.
The configuration for maintaining the winding state of the winding band 60 is not limited to the through hole 61 through which the attachment bolt 36 penetrates. For example, a tip end portion of the winding band 60 may be fixed to an outer surface of the main body portion 53. In addition, a holding member may be separately provided for maintaining the winding state of the winding band 60.
The winding band 60 may extend from the lower end portion of the rear side edge portion forming the opening 54 of a part of the peripheral portions 52 located on the vehicle inner side.
The winding band 60 may extend from the flap portion 55.
The winding band 60 may be provided separately from the wrapping material 50.
The attachment projection may be any member that can be attached to the side frame portion 21, and may be changed to a member different from the attachment bolt 36, for example, a pin, a clip, a hook, or the like.
Instead of the seat back 12 of the vehicle seat 10, the housing portion 25 may be provided in the side wall portion of the vehicle, and the side airbag apparatus 30 may be incorporated therein.
The side airbag apparatus 30 may also be applied to a side airbag apparatus 30 that, in a vehicle provided with the vehicle seat 10 whose seat back 12 is disposed toward a direction different from the front of the vehicle, for example, toward a lateral side, when impact is applied from the rear side (the lateral side of the vehicle) to the vehicle seat 10, protects an upper body of an occupant P from the impact. In addition, the deployment and expansion direction of the airbag 32 may be the upper-lower direction of the vehicle or the vehicle width direction, depending on the specification.
The vehicle to which the side airbag apparatus 30 is applied is not limited to a private car, and may be various industrial vehicles.
The side airbag apparatus 30 is may also be applied to a conveyance other than the vehicle, for example, a conveyance such as an aircraft or a ship.

According to an aspect of the invention, there is provided a side airbag apparatus including: an airbag module including: a side airbag configured to be deployed and inflated when a gas is filled inside the side airbag, and a retainer configured to attach the side airbag in a folded state to an attachment target of a conveyance; and a wrapping material that houses the airbag module and configured to be broken when the side airbag is deployed and inflated, the wrapping material including a winding band wound around the wrapping material in a state in which the airbag module is housed.

According to the above configuration, since the winding band is wound around the wrapping material, a gap between the airbag module and the wrapping material can be reduced, and entry of foreign matters into the wrapping material can be prevented.

In the side airbag apparatus, it is preferable that the winding band is provided integrally with the wrapping material. According to this configuration, a number of components can be reduced as compared with a case where the wrapping material and the winding band are provided separately.

In the side airbag apparatus, it is preferable that the retainer includes an attachment protrusion configured to be attached to the attachment target of the conveyance, and the winding band includes a through hole penetrated by the attachment projection in a state in which the winding band is wound around the wrapping material. According to this configuration, the winding band can be held in a state in which the winding band is wound around the wrapping material by using the attachment projection configured to be attached to the attachment object of the vehicle. Accordingly, a member for holding the winding band in the wrapped state is not separately provided, which contributes to prevention of increase in the number of components.

In the side airbag apparatus, it is preferable that the winding band includes a breaking portion, which is more fragile than the other portions of the winding band, at a position corresponding to a direction in which the side airbag is deployed and inflated. According to this configuration, the breaking portion is rapidly broken when the side airbag is deployed and inflated. Accordingly, since the side airbag can be inflated and inflated rapidly, a function of protecting an occupant is ensured.

In the side airbag apparatus, it is preferable that the side airbag apparatus includes an inflator configured to generate a gas configured to inflate the side airbag, the retainer includes an insertion opening into which the inflator is inserted, and the insertion opening is exposed to an outside of the wrapping material. According to this configuration, in a case where the inflator is to be inserted into the retainer housed in the wrapping material, since the insertion opening of the retainer is exposed, the inflator can be easily inserted. This contributes to improvement of assembling property of the side airbag apparatus.

In the side airbag apparatus, it is preferable that peripheral portions of a fabric piece that overlap each other are joined so that the wrapping material is formed into a bag shape, and the wrapping material includes an opening at an unjoined portion of the peripheral portions, and the winding band blocks the opening in the state in which the winding band is wound around the wrapping material. According to this configuration, the airbag module is inserted into the wrapping material through the opening provided on the wrapping material. Further, since the winding band is wound around the wrapping material so as to block the opening, intrusion of foreign matters from the opening is prevented. Therefore, it contributes to prevention of intrusion of foreign matters while ensuring the assembling property.

According to another aspect of the invention, there is provided a wrapping material configured to house an airbag module including: a side airbag configured to be deployed and inflated when a gas is filled inside the side airbag, and a retainer configured to attach the side airbag in a folded state to an attachment target of a conveyance, and including a winding band wound around the wrapping material in a state in which the airbag module is housed.

According to the side airbag apparatus and the wrapping material, intrusion of foreign matters can be prevented.

What is claimed is:

1. A side airbag apparatus comprising:
an airbag module including: a side airbag configured to be deployed and inflated when a gas is filled inside the side airbag, and a retainer configured to attach the side airbag in a folded state to an attachment target of a conveyance; and
a wrapping material that houses the airbag module and configured to be broken when the side airbag is deployed and inflated,
wherein the wrapping material includes a winding band wound around the wrapping material in a state in which the airbag module is housed.

2. The side airbag apparatus according to claim 1,
wherein the winding band is provided integrally with the wrapping material.

3. The side airbag apparatus according to claim 1,
wherein the retainer includes an attachment protrusion configured to be attached to the attachment target of the conveyance, and
wherein the winding band includes a through hole penetrated by the attachment projection in a state in which the winding band is wound around the wrapping material.

4. The side airbag apparatus according to claim 1,
wherein the winding band includes a breaking portion, which is more fragile than the other portions of the winding band, at a position corresponding to a direction in which the side airbag is deployed and inflated.

5. The side airbag apparatus according to claim 1, comprising:
an inflator configured to generate a gas configured to inflate the side airbag,
wherein the retainer includes an insertion opening into which the inflator is inserted, and
wherein the insertion opening is exposed to an outside of the wrapping material.

6. The side airbag apparatus according to claim 1,
wherein peripheral portions of a fabric piece that overlap each other are joined so that the wrapping material is formed into a bag shape, and the wrapping material includes an opening at an unjoined portion of the peripheral portions, and
wherein the winding band blocks the opening in the state in which the winding band is wound around the wrapping material.

7. A wrapping material configured to house an airbag module including: a side airbag configured to be deployed and inflated when a gas is filled inside the side airbag, and a retainer configured to attach the side airbag in a folded state to an attachment target of a conveyance,
wherein the wrapping material comprises a winding band wound around the wrapping material in a state in which the airbag module is housed.
